(19) United States
(12) Patent Application Publication
(10) Pub. No.: US 2006/0098119 A1
(43) Pub. Date: May 11, 2006

(54) Mobile terminal

(75) Inventor: Sung-Ho Lee, Suwon (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/267,745

(22) Filed: Nov. 4, 2005

(30) Foreign Application Priority Data
Nov. 5, 2004 (KR) 89943/2004

(51) Int. Cl. H04N 5/225

(52) U.S. Cl. 348/376

(57) ABSTRACT

A mobile terminal which includes: a first body; a second body slidingly opened or closed with respect to the first body; and a camera mounted on the first body and exposed to the outside when the second body is opened in relative to the first body can minimize contamination of a lens of the camera due to dust from the outside and prevent damage to the lens because of scratches thereon generated by a physical effect.

### CROSS REFERENCE TO THE RELATED APPLICATIONS

Pursuant to 35 U.S.C. §119(a), this application claims the benefit of earlier filing date and right of priority to Korean Application No. 89943/2004, filed on Nov. 5, 2004, the contents of which are hereby incorporated by reference herein in their entirety.

### BACKGROUND OF THE INVENTION

### CROSS REFERENCE TO THE RELATED APPLICATIONS

Pursuant to 35 U.S.C. §119(a), this application claims the benefit of earlier filing date and right of priority to Korean Application No. 1089943/2004, filed on Nov. 5, 2004, the contents of which are hereby incorporated by reference herein in their entirety.

### BACKGROUND OF THE INVENTION

1. Field of the Invention

The present invention relates to a slide mobile terminal, and more particularly, to a slide mobile terminal constructed to protect a camera lens.

2. Description of the Background Art

In general, among all kinds of convenience devices providing convenience to people, mobile terminals having recently been spread rapidly are wireless mobile communications devices that users can use anywhere, either indoors or outdoors, simply carrying the mobile terminals with themselves and that the users can also use while moving. With the industrial development, initial functions of such mobile terminals which used to be limited to the transmission and reception of voice are gradually expanded, so that the mobile terminals have been developed into devices that perform multiple functions such as Internet connections as well as text message transmissions, transmission of various information and the like.

Also, mobile terminals provided with a camera module for capturing an image or video and allowing image transmission and image communications, and a color liquid crystal for displaying image information are being developed.

Various types of mobile terminals are available such as flip type, folder type, slide type or the like.

FIGS. 1 and 2 are perspective views illustrating a slide mobile terminal in accordance with a conventional art.

As shown therein, a slide mobile terminal in accordance with a conventional art includes a first body 10 provided with a liquid crystal 5 for displaying various text information and image information on one surface thereof, and a second body 20 slidingly opened or closed with respect to the first body 10 and provided with a keypad 15 for inputting information. A speaker 22 for emitting sound information such as voice to the outside is provided on an upper portion of the first body 10. A microphone 23 capable of inputting voice information is provided on a lower portion of the second body 20.

In addition, as shown in FIG. 2, a mobile rechargeable battery 25 for supplying power to the mobile terminal is detachably coupled to the back of one surface of the second body 20 provided with the keypad 15, and a camera 30 including a lens, a flash or the like to receive an image from the outside is provided on an upper portion of the back thereof.

Such a conventional art slide mobile terminal is carried in a state that the first body 10 is closed with respect to the second body 20. In addition, in a state that the second body 20 is opened in relative to the first body 10, voice communications are made. Also, a desired image can be captured through the camera 30.

However, the conventional art slide mobile terminal having such a construction has the camera installed on the back of the second body 20. Thus, since the camera is always exposed to the outside no matter whether the first body and the second body are opened or closed with respect to each other, it cannot be safely protected from an outside impact.

In addition, since the lens of the camera is always exposed to the outside, a surface of the lens is subject to contamination caused by dust from the outside and scratches on the surface are likely to be generated by an outside physical effect. Accordingly, deterioration in image quality is caused such as a fuzzy captured image, generation of afterimages or the like.

Thus, the conventional art slide mobile terminal not only causes inconvenience for use but also lowers product quality and reliability.

### SUMMARY OF THE INVENTION

Therefore, an object of the present invention is to provide a slide mobile terminal constructed to prevent damage and contamination of a camera which are caused by an outside impact and dust.

To achieve these and other advantages and in accordance with the purpose of the present invention, as embodied and broadly described herein, there is provided a mobile terminal comprising: a first body; a second body slidingly opened or closed with respect to the first body; and a camera mounted on the first body and exposed to the outside when the second body is opened in relative to the first body.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view illustrating the front of a slide mobile terminal in accordance with a conventional art;

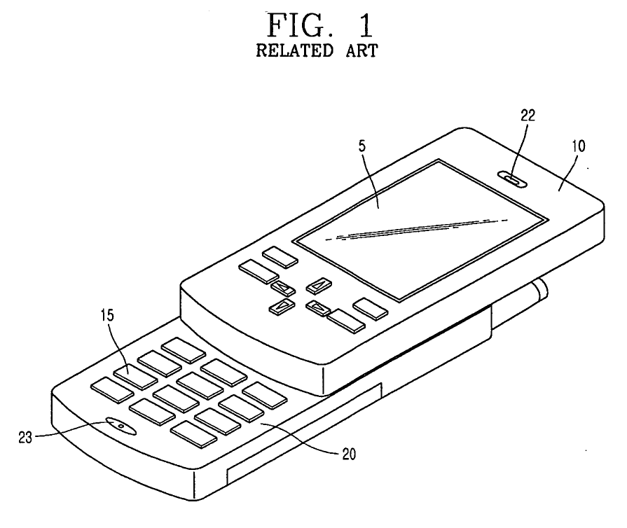

FIG. 2 is a perspective view illustrating the back of a slide mobile terminal in accordance with the conventional art;

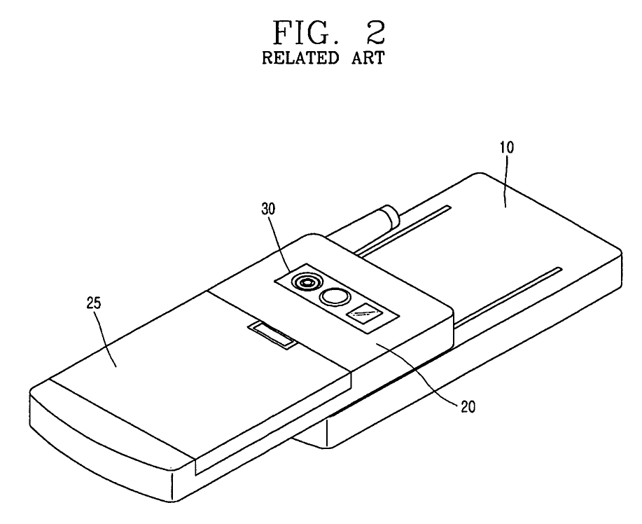

FIG. 3 is a perspective view illustrating the front of a mobile terminal in accordance with one embodiment of the present invention;

FIG. 4 is a perspective view illustrating the back of a mobile terminal in accordance with the one embodiment of the present invention;

FIG. 5 is a sectional view showing the mobile terminal in accordance with the present invention.

FIG. 6 is a enlarged view of A part of FIG. 5.

### DETAILED DESCRIPTION OF THE PREFERRED EMBODIMENTS

Reference will now be made in detail to a mobile terminal in accordance with one embodiment of the present invention, examples of which are illustrated in the accompanying drawings.

Even if a plurality of preferred embodiments of a mobile terminal according to the present invention may exist, the most preferred embodiment will be explained hereinafter.

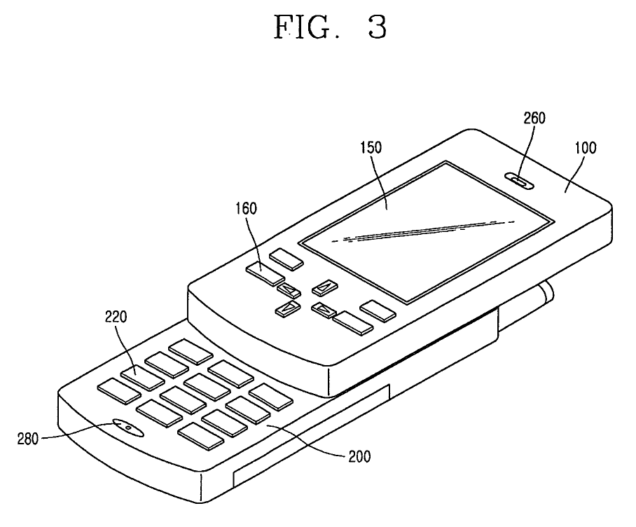

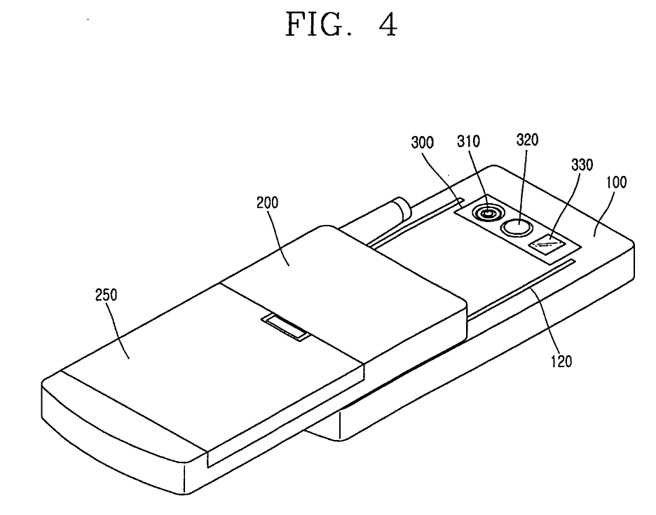

FIG. 3 is a perspective view illustrating the front of a mobile terminal in accordance with one embodiment of the present invention. FIG. 4 is a perspective view illustrating the back of the mobile terminal in accordance with the one embodiment.

As shown therein, a mobile terminal in accordance with one embodiment includes a first body 100, a second body 200 slidingly opened or closed with respect to the first body 100, and a camera 300 mounted on the first body 100 and exposed to the outside when the second body 200 is opened in relative to the first body 100.

A display 150 for displaying various letters and image information is provided on the front of the first body 100, and a first keypad 160 for inputting a function of moving a direction of a cursor and a special function is provided at a lower side of the display 150. A second key pad 220 for inputting letter and number information is mounted on a part of the second body 200 which is exposed when the second body 200 is opened in relative to the body 100.

A pair of sliding grooves 120 for allowing the second body 200 to be slidingly opened or closed with respect to the first body 100 are provided on the back of the first body 100. A stopper (not shown) is formed on the first and second bodies 100 and 200 such that the second body 200 can be stopped after moving a predetermined distance along the sliding grooves 120.

The camera 300 is mounted between the sliding grooves 120 on part of the first body 100 which is exposed when the second body 200 is opened in relative to the first body 100. That is, since mounted on the back of the first body 100 provided with the display 150, the camera 300 is exposed to the outside or covered inside the first body 100 and the second body 200 according to whether the second body 200 is opened or closed.

The camera 300 includes a lens 310 receiving an outside image and a flash 320 for irradiating light on the outside image, all of which are exposed to the outside. In addition, the camera 300 further includes a reflecting mirror 330 for imaging an outside image for precise focusing of the outside image.

Meanwhile, a speaker 260 for emitting a voice signal to the outside is mounted on the upper portion of the front of the first body 100 having the display 150. A microphone 280 receiving a voice signal from the outside is mounted on the lower portion of the second body 200 having the keypad 220.

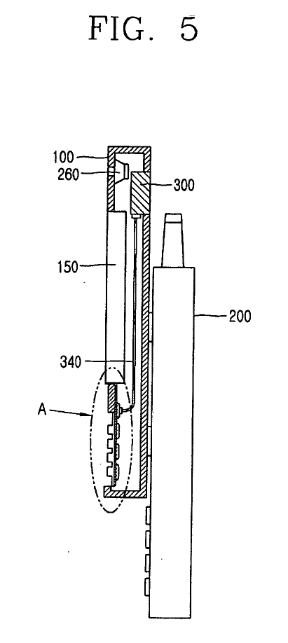

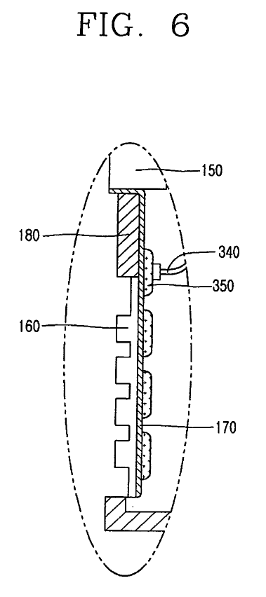

FIG. 5 is a sectional view of the mobile terminal in accordance with the present invention and FIG. 6 is a enlarged view of A part of FIG. 5. As shown in FIG. 5 and FIG. 6, a first PCB 170 is installed at a lower end inside the first body 100, supports the first key pad 160 and receives an input signal of the first key pad 160 and the display 150. More detailed, The PCB 170 supports the key pad 160 and at least one electronic element 180 associated with the display 150 in one side and receives/transmits a signal from/to the key pad 160 and the electronic element. It 170 also supports at least one electronic element 350 associated with the camera 300 in another side and receive/transmit a signal from/to the camera 300.

The camera 300 is installed at a region opened and closed according to movement of the second body 200, namely, at a region corresponding to a rear surface of an upper portion of the first body 100 on the drawing, and a second PCB 340 (e.g., flexible PCB) for supplying power and transferring a signal to the camera 300 is connected between the PCB 170 and the camera 300.

A method for voice communications using the mobile terminal in accordance with the one embodiment of the present invention having such a construction is the same as that of the conventional art. Hereinafter, a method for using the camera in accordance with the present invention will be described.

When the user wants to capture an outside image using the mobile terminal in accordance with one embodiment, the second body 200 is opened in relative to the first body 100 along the sliding grooves 120. At this time, the camera 300 mounted on the back of the first body 100 and covered between the first body 100 and the second body 200 by means of the second body 200 is exposed to the outside. While looking at an image being displayed on the display 150 through the lens 310 of the camera 300, the user performs the capturing.

In addition, after the user finishes the capturing of the outside image or does not want the capturing, the second body 200 having been opened in relative to the first body 100 is returned to its initial position. That is, the second body 200 is closed. At this time, the camera 300 is covered by the inside formed by the first body 100 and the second body 200.

As described so far, the mobile terminal in accordance with the present invention can minimize contamination of the lens due to dust from the outside and prevent damage to the lens of the camera because of scratches thereon generated by a physical effect.

Accordingly, deterioration in quality of an image being captured is prevented and product reliability and competitiveness are improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A mobile terminal comprising:
a first body;
a second body slidingly opened or closed with respect to the first body; and
a camera mounted on the first body and exposed to the outside when the second body is opened in relative to the first body,

2. The terminal of claim 1, wherein the first body comprises:
a display;
a keypad;
a first printed circuit board configured to receive/transmit a first signal from/to at least one of the display and the keypad in one side and to receive/transmit a second signal from/to the camera in another side.

3. The terminal of claim 2, wherein the first printed circuit board comprising a first electronic element associated with the display in the one side.

4. The terminal of claim 2, wherein the first printed circuit board comprising a second electronic element associated with the camera in the another side.

5. The terminal of claim 1, wherein the first printed board transmitting/receiving the second signal from the camera through a second printed circuit board.

6. The terminal of claim 1, wherein the first body is provided with a display on the front thereof and a camera on the back thereof.

7. The terminal of claim 1, wherein the camera is mounted on part of the first body which is exposed when the second body is opened in relative to the first body.

8. The terminal of claim 7, wherein the second body has a keypad mounted on its part which is exposed when the second body is opened in relative to the first body.

9. The terminal of claim 1, wherein the camera comprises:
a lens receiving an outside image; and
a flash for irradiating light on the outside image.

10. The terminal of claim 9, further comprising:
a reflecting mirror for imaging an outside image for precise focusing of the outside image.

11. The terminal of claim 1, wherein the first body is provided with a keypad on one side thereof (front) and a camera on the other side (back).

12. The terminal of claim 11, wherein the camera is mounted on part of the first body which is exposed when the second body is opened in relative to the first body.

13. The terminal of claim 12, wherein the second body is provided with a display on its part which is exposed when the second body is opened in relative to the first body.

14. The terminal of claim 11, wherein the camera is connected with the PCB by a flexible printed circuit board supplying power and transferring a signal to the camera.

15. A mobile terminal comprising:
a first body provided with a display;
a second body slidingly opened or closed with respect to the first body and provided with a keypad; and
a camera mounted on an opposite surface to one surface of the first body provided with the display and exposed to the outside when the second body is opened in relative to the first body.

16. The terminal of claim 15, wherein the camera comprises:
a lens receiving an outside image; and
a flash for irradiating light on the outside image.
